(19) United States
(12) Patent Application Publication
(10) Pub. No.: US 2012/0064328 A1
(43) Pub. Date: Mar. 15, 2012

(54) DECORATIVE ELEMENT FOR DECORATION OF SURFACES, PREFERABLY WALL SURFACES

(76) Inventor: Elek Bindics, Szodliget (HU)

(21) Appl. No.: 13/321,268

(22) PCT Filed: May 20, 2010
(86) PCT No.: PCT/HU2010/000058

§ 371 Date: Nov. 18, 2011

(30) Foreign Application Priority Data
May 21, 2009 (HU) U 09 00106

(51) Int. Cl. B32B 3/00; D04H 13/00

(52) U.S. Cl. 428/220; 442/327

(57) ABSTRACT

The subject of the invention is a decorative element for decoration of surfaces, preferably wall surfaces, and application of this decorative element gives the impression of viewing painted decoration, pictures, frescos on surface, preferably wall surface.

The decorative element according to the invention consists of a raw material and a paint layer applied on the raw material, its characteristic is, that the raw material (2) of the decorative element (1) consists of piles of disordered fibres of lax structure, non-woven, thin, filmy, transparent fibres, and on the said raw material (2) color paint layer (3) and areas without paint layer (4) are formed, and areas without paint (4) are formed on such areas of the decorative element (1), where the color of the surface (6) preferably the wall surface is to be enforced.

The subject of the invention is a decorative element for decoration of surfaces, preferably wall surfaces, and application of this decorative element gives the impression of viewing painted decoration, pictures, frescos on surface, preferably wall surface.

There are various solutions for decorating surfaces and wall surfaces. One of the simplest way was the solution, when a pattern was applied to a wall surface provided with proper base color with the help of a cylinder with a motive. A more sophisticated, and considerably more expensive solution is, very seldom used nowadays, when the suitable motives, pictures, frescos are applied or painted directly to the wall. Painting the wall surface is very labour-intensive, takes a long time, needs proper skills and ability, so all in all, a very expensive solution. Nowadays a significantly cheaper and widespread solution, wallpapering is used for decoration of wall surfaces. Different materials and color wallpapers help provide a variety of wall surfaces, this solution even makes possible to cover whole wall surfaces with large-size pictures.

In the state of the art the DE 102005013625 patent application published on 5 Oct. 2006 makes known such decorative wallpaper, that has an outside seamed exposed layer, and an inside non-perforated waterproof layer. The wallpaper has two layers, the outside, visible layer has a seamed motive, the layer next to the wall is a layer impenetrable with needle. The part next to the wall is textile, for example non-woven fleece. The outside and inside layers are fixed together with adhesive. The visible layer is paper or cartoon, or material coated with plastic and/or fleece. The layer next to the wall is impenetrable for the wallpaper adhesive. The process has two steps, in the first step the outside layer is decorated by embroidering process, in the second step it is fixed to the inside layer.

The CN 201106141 utility model published on 27 Aug. 2008 describes a wallpaper of fabric base. The wallpaper includes a base layer, an adhesive layer and a surface layer. The fabric layer-base wallpaper can be described as follows. The basic layer of the wallpaper is a fabric that can be fibrous, non-woven fabric. Or it can be a composite PVC layer that contains traditional woven fabric and PVC. The wallpaper produced with this method has not only ten times higher tensile strength compared to the value prescribed for wallpapers, but it is also drip resistant and besides lends a pleasant feeling for people.

The solutions described above and the decorating elements available in commerce do not make possible to decorate surfaces or interior wall surfaces in an easy way conforming with the demand in such a way, that the viewer could have the impression, that the given picture or motive had been painted on the surface, preferably wall surface.

When working out the solution according to the invention we aimed to create such a decorative element, that allows the decoration of surfaces, preferably wall surfaces in such a way, that the decoration can be applied and fixed on the given surface, preferably wall surface, on an optional, or smaller part of the surface, or in given case to the whole surface in a known simple way, to give the viewer the impression, that the decoration has been directly painted on the surface, preferably on the wall surface.

When creating the solution according to the invention, we realized as an inventor's step, that in case non-woven, very thin, transparent, filmy material is printed with decorative motives in the known way, and the decorative element itself, made this way, or in case of a decorative element of larger surface, part elements of the decorative element are fitted next to each other on a surface, preferably on a wall surface, then the set aim can be achieved.

The invention is a decorative element for decoration of surfaces, preferably wall surfaces consisting of a raw material and a paint layer applied on the raw material. The raw material of the decorative element consists of piles of disordered fibres of lax structure, non-woven, thin, filmy, transparent fibres, and on the said raw material color paint layer and areas without paint layer are formed, and areas without paint are formed on such areas of the decorative element, where the color of the carrying surface is to be enforced.

In one preferred embodiment of the solution according to the invention, the thickness of the raw material is 0.01 mm-0.5 mm, preferably 0.1 mm.

In another preferred embodiment of the solution according to the invention, the decorative element is formed as one unit.

In a further preferred embodiment of the solution according to the invention, the decorative element is formed with using two or more decorative element parts accurately fitting the decorative element parts to each other.

In a further preferred embodiment of the solution according to the invention, the material of the surface is in given case textile, or plastic, or a wall surface prepared for wallpapering.

The solution according to the invention is furthermore set forth by the attached figures:

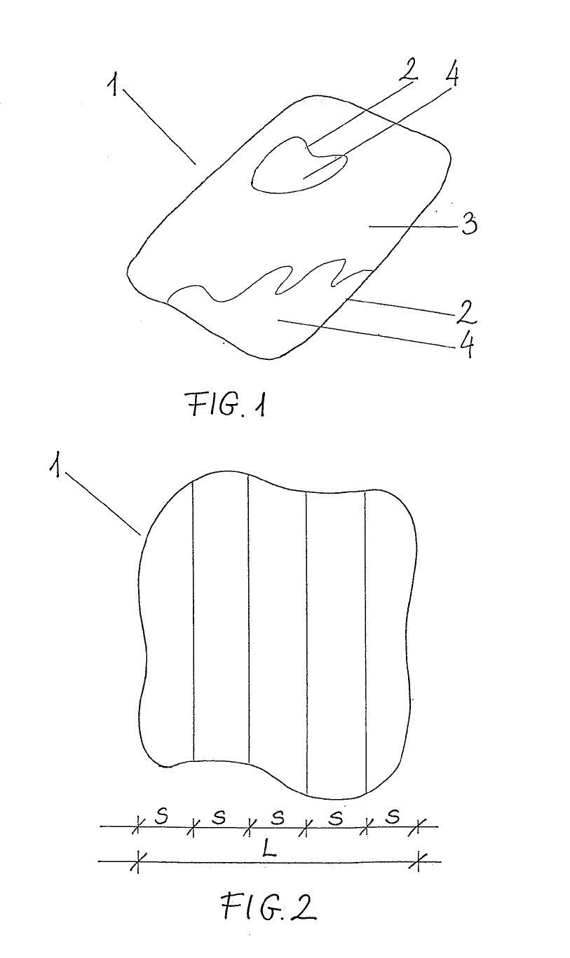

The FIG. 1 shows a possible realization of the decorative element according to the invention, in view.

The FIG. 2 shows a possible realization of the decorative element according to the invention applying decorative element parts, in view.

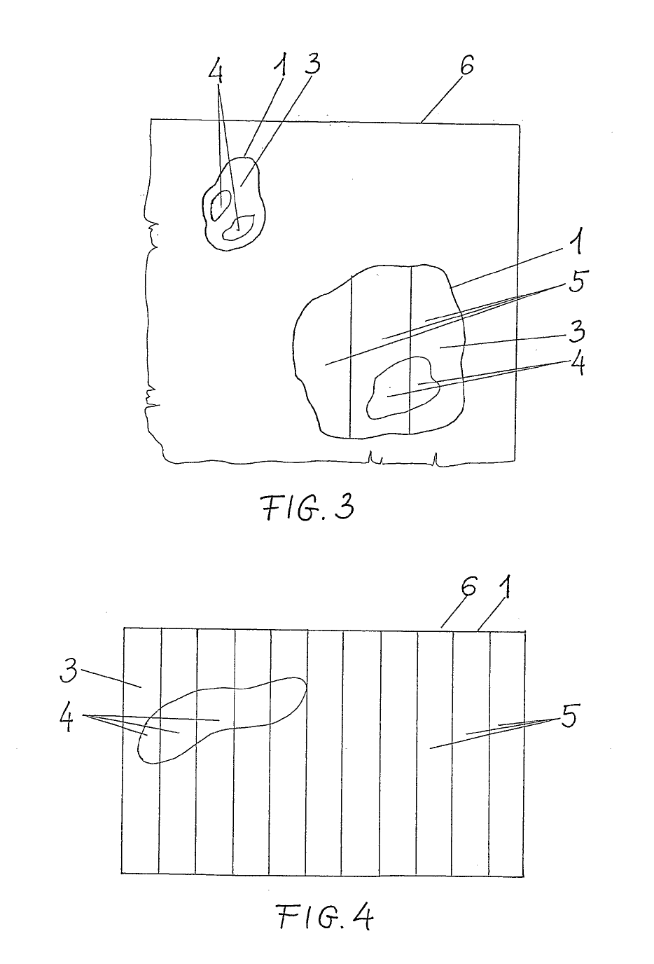

The FIG. 3 shows a possible placement of the solutions of the decorative element according to the invention shown on the FIGS. 1 and 2, on a wall surface, in view.

The FIG. 4 shows a possible realization of the decorative element according to the invention when the decorative element covers a whole wall surface.

The FIG. 1 shows a possible realization of the decorative element 1 according to the invention in view. The figure shows the decorative element 1, consisting of the raw material 2, the paint layer 3 applied on the raw material 2 and the area without paint layer 4. It can be seen in the figure, that there are areas without paint layer 4 on the decorative element 1, where the raw material 2 can be seen.

The FIG. 2 shows a possible realization of the decorative element 1 according to the invention applying decorative element parts 5, in view. The figure shows such a realization of the decorative element 1, when we want to decorate the surface 6 with such large size of decorative element 1, in which case the “L” width size of the decorative element 1 exceeds the “S” width size of the raw material 2 available in commerce, or its “L” width size exceeds the width size of the machine putting up the paint layer 3 on the raw material 2, or the size of the decorative element 1 exceeds the practical limits of its fixing to the surface 6. It can be seen in the figure, that this case the decorative element 1 is divided into decorative element parts 5 adjusting to the “S” produced width size of the applied raw material 2 and the given motive parts of the decorative element 1 are positioned on these decorative element parts 5. Following this in the known way, the decorative element parts 5 properly cut and fitted next to each other are put on the surface 6, compiling this way the decorative element 1.

The FIG. 3 shows a possible placement of the solutions of the decorative element 1 according to the invention shown on the FIGS. 1 and 2, on the surface 6, in view. It can be seen in the figure, that at an optional point of the surface 6 the decorative elements 1 can be placed in the known way. The decorative element 1 according to the realization shown in the FIG. 1 can be seen, as well as the decorative element 1 compiled from several decorative element parts 5 shown in the FIG. 2.

The FIG. 4 shows a possible realization of the decorative element according to the invention when the decorative element 1 covers a whole wall surface. It can be seen in the figure, that with the help of the decorative element 1 according to the invention the decoration of whole wall surfaces can be solved if demanded, in such a way, that the decorative element 1 is divided into decorative element parts 5 adjusting to the “S” produced width size of the applied raw material 2 and the given motive parts of the decorative element 1 are positioned on these decorative element parts 5. Following this in the known way, the decorative element parts 5 properly cut and fitted next to each other are put on the surface 6, compiling this way the decorative element 1.

In case of a possible concrete realization of the solution according to the invention as raw material 2 of the decorative element 1 a very thin, filmy, transparent, non-woven material is used. The most important consideration of the forming of the decorative element 1 is the choice of the raw material 2, as only materials with such properties make possible the creation of such a decorative element 1, that can give the impression as if the given picture, motive had been directly put up to the surface, preferably to the wall surface by paint method. The white, transparent material used as liner of embroidery of 30-50 g/m² weight made from 100% cellulose, or the mixture of cellulose, viscose and polyester raw materials has such characteristics. Following the correct choice of the raw material 2 the required motive is printed on the raw material 2 in the known way by UV printer, this case in such a way, that a paint layer 3 of all colors except for white is printed on the raw material 2. On the white parts of the motive the white color is not printed on the raw material 2. Following this the decorative element 1 is cut out of the printed material.

In case of another possible concrete realization of the solution according to the invention a decorative element 1 of such size is made, where the “L” width size of which exceeds the “S” width size of the raw material 2 used, available in commerce. First the raw material 2 with suitable characteristics for the formation of the invention is chosen. This case the thin, filmy, transparent, non-woven fleece wallpaper raw material was chosen. This case the decorative element 1 is divided into decorative element parts 5 adjusting to the “S” produced width size of the applied raw material 2 and the given motive parts of the decorative element 1 are carried on the raw material 2 of these decorative element parts 5 in accordance with described above. This case the unity of the decorative element 1 is realized, when the proper decorative element parts 5 are accurately fitted next to each other.

The decorative elements 1 produced as described above are put up on the surface 6 with the help of the common method used with fleece wallpapers. The base surface is a surface suitable for wallpapering, a levelled, ground wall surface, mostly white, but the decorative element 1 according to the invention can be applied on a surface 6 different from white, primarily of light shade, or even on a painted, in given case colored, ready surface as well.

The carrying of decorative element 1 on the prepared surface 6 takes place with wallpaper adhesive. During this process it must be taken into consideration, that the wallpaper adhesive might flow through the decorative element 1 of very thin raw material 2, so such an adhesive must be used, that does not leave a blot on the decorative element 1, so it does not get patched.

When applying the decorative element 1 according to the invention, the picture, the motive is printed on a transparent raw material 2 in such a way, that a certain color of the picture, motive is not printed on the raw material 2, so the picture, or motive will become unified of contour with the help of the given color of the surface 6 after having placed the decorative element 1 on the surface 6 of given color, because the given colour is ensured by the surface 6, and resulting from the thinness, transparency, filminess and porous characteristics of the raw material 2, the decorative element 1 will seem on the surface 6 as if the given picture, motive had been directly painted on the wall.

When choosing the raw material of the decorative element 1 according to the invention, only materials with piles of disordered fibres of lax structure and piles of fibres of spread sheet-like, where the fibres are fixed to each other with mechanical or chemical processes, not a raw material where threads cross each other in a proper system, or fibres embracing each other can be used. Textiles used as gauze or fleece base are such “non-woven fabrics” in textile industry.

It is also an important consideration when choosing the material of the decorative element 1 according to the invention to make the accurate choice of the thickness of the raw material, so the thickness of the applied raw material 2 is 0.01 mm-0.5 mm, preferably 0.1 mm.

In case of the decorative element 1 according to the invention the fixing of the motive, picture on the raw material 2 can take place with an UV printer, or with a digital printer, or with any known printer, suitable for printing on the raw material 2 according to the invention. As paint, toners used in these printers can be applied.

When applying the decorative element 1 according to the invention, after having placed the decorative element 1 on the surface 6 it is preferable to apply matte lacquer, or other surface treating stuff on the surface.

If there is demand, the decorative element 1 according to the invention can be applied on textile, or plastic sheets as surface 6 with using suitable adhesives. The material of the decorative element 1 is of porous structure, therefore such adhesive should be used, that can cover the whole cross-section, that is the full depth of the porous surface. However it does not work in case of a textile, or plastic surface, as in case of a plastic surface the adhesive is not absorbed in the material, so it does not link the two surfaces, but resulting from the much more flexible characteristics of the raw material it stretches due to moisture, so in case of using such adhesive, creases are created on the material.

In case of gluing the decorative element 1 on textile, or plastic surface it is preferable, if white or colorless contact or textile adhesive is used, and this adhesive is applied in such a way, in an even layer on the decorative element 1 of vlies material, that the adhesive does not wet the outside layer of the vlies material. If possible, it is preferable to apply the adhesive on both the textile, respectively on the plastic surface as well, and press the surfaces provided with adhesive together, according to how contact adhesives work. In case of textiles it can be easily done with eg. a vacuum press, possibly a thermal press can be used as well. In case of plastic sheets a laminating machine can be used for pressing.

The advantage of the solution according to the invention is, that with its help surfaces, preferably wall surfaces can be provided with decoration, using simple materials, easy technology, in given case sticker-like with a decorating motive, or application of larger decorating elements can imitate the effect of decoration of the surface by paint method. With the application of the decorative element according to the invention, as well as graphical solutions in case of walls the effect of fresco painting can be achieved as well.

A further advantage is, that the decorative element can be used in an inflammable space as well, because the material is so thin.

A further advantage is, that following the carrying of the decorative element according to the invention on the wall surface, the touch of the wall surface is pleasant.

### LIST OF REFERENCES

1—decorative element
2—raw material
3—paint layer
4—area without paint layer
5—decorative element part
6—surface
L—width
S—width

1. Decorative element for decoration of surfaces, preferably wall surfaces consisting of a raw material and a paint layer applied on the raw material,
characterized by that,
the raw material (2) of the decorative element (1) consists of piles of disordered fibres of lax structure, non-woven, thin, filmy, transparent fibres, and on the said raw material (2) color paint layer (3) and areas without paint layer (4) are formed, and areas without paint (4) are formed on such areas of the decorative element (1), where the color of the surface (6) preferably the wall surface is to be enforced.

2. Decorative element according to claim 1, characterized by that, the thickness of the raw material (2) is 0.01 mm-0.5 mm, preferably 0.1 mm.

3. Decorative element according to claim 1, characterized by that, the decorative element (1) is formed as one unit.

4. Decorative element according to claim 1, characterized by that, the decorative element (1) is formed with using two or more decorative element parts (5) accurately fitting the decorative element parts (5) to each other.

5. Decorative element according to claim 1, characterized by that, the material of the surface (6) is in given case textile, or plastic, or a wall surface prepared for wallpapering.
